(19) United States
(12) Patent Application Publication
(10) Pub. No.: US 2025/0267690 A1
(43) Pub. Date: Aug. 21, 2025

(54) USER EQUIPMENT REPORTING ENHANCEMENTS FOR COHERENT JOINT TRANSMISSION

(71) Applicant: Apple Inc., Cupertino, CA (US)

(72) Inventors: Haitong Sun, Cupertino, CA (US); Dawei Zhang, Saratoga, CA (US); Wei Zeng, Saratoga, CA (US); Hong He, San Jose, CA (US); Huaning Niu, San Jose, CA (US); Ankit Bhamri, Bad Nauheim (DE); Jie Cui, San Jose, CA (US)

(21) Appl. No.: 19/054,374

(22) Filed: Feb. 14, 2025

Related U.S. Application Data
(60) Provisional application No. 63/554,824, filed on Feb. 16, 2024.

(51) Int. Cl. H04W 72/51; H04L 5/00; H04W 24/10

(52) U.S. Cl. CPC H04W 72/51; H04L 5/0048; H04W 24/10

(57) ABSTRACT

A baseband processor includes at least one processor core, and memory coupled with the at least one processor core. The memory stores instructions that, when executed by the at least one processor core, cause the baseband processor to at least receive configuration signaling that indicates a channel measurement resource (CMR) configuration identifying a set of channel state information (CSI) reference signal (CSI-RS) resources. The set of CSI-RS resources include different subsets of one or more CSI-RS resources for different TRPs in a set of TRPs identified for a coordinated joint transmission (CJT) between the set of TRPs and a user equipment (UE). Execution of the instructions further causes the baseband processor to measure at least some of the CSI-RS resources in the set of CSI-RS resources, and generate, for transmission, a CSI report based at least in part on the measurement of the at least some of the CSI-RS resources.

### CROSS REFERENCE TO RELATED APPLICATION

This application is a nonprovisional and claims the benefit under 35 U.S.C. § 119(e) of U.S. Provisional Patent Application No. 63/554,824, filed Feb. 16, 2024, the contents of which are incorporated herein by reference as if fully disclosed herein.

### TECHNICAL FIELD

This application relates generally to wireless communication systems, including systems, apparatuses, and methods in which a user equipment (UE) may measure time and frequency resources associated with multiple channel state information (CSI) reference signal (CSI-RS) resources and transmit, to a network, a CSI report pertaining to a coherent joint transmission (CJT).

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 illustrates a wireless communication system including an example user equipment (UE) and set of transmission and reception points (TRPs) that may participate in a CJT.

FIG. 2 shows an example method of wireless communication by a UE, according to one or more aspects described herein.

FIG. 3A shows an example timeline for transmitting 2 channel state information (CSI) reference signal (CSI-RS) resources per TRP, with the CSI-RS resources for different TRPs being transmitted in consecutive slots.

FIG. 3B shows an example timeline for transmitting 4 CSI-RS resources per TRP, with the CSI-RS resources for each TRP being transmitted in a respective pair of consecutive slots.

FIG. 4 shows an example timeline for transmitting 4 CSI-RS resources per TRP, with all of the CSI-RS resources being transmitted in 2 slots.

FIG. 5A shows an example CSI report configuration including a single non-zero power (NZP) CSI-RS resource set, with the single NZP CSI-RS resource set including four subsets of CSI-RS resources, and with each subset of CSI-RS resources including 4 CSI-RS resources.

FIG. 5B shows an example CSI report configuration including 4 NZP CSI-RS resource sets.

FIG. 6A shows a reproduction of Table 5.4-1 of 3GPP Technical Specification (TS) 38.214.

FIG. 6B shows a reproduction of Table 5.4-2 of 3GPP TS 38.214.

FIG. 7 shows an example method of wireless communication by a network device, according to one or more aspects described herein.

FIG. 8 illustrates an example architecture of a wireless communication system, according to one or more aspects described herein.

FIG. 9 illustrates an example system for performing signaling between a wireless device and a network device, according to one or more aspects described herein.

FIG. 10 illustrates example components of a UE, according to one or more aspects described herein.

### DETAILED DESCRIPTION

Various embodiments are described with regard to a processor (e.g., a baseband processor), a wireless device (e.g., a user equipment (UE)), or a network device. However, reference to a processor, wireless device, or network device is merely provided for illustrative purposes. The example embodiments may be utilized with any electronic component or device that may establish a wireless connection and is configured with the hardware, software, and/or firmware to exchange information and data over the wireless connection. Therefore, the processors, wireless devices, and network devices described herein are used to represent any appropriate electronic components or devices.

Multiple transmission and reception point (Multi-TRP) operation involves multiple TRPs transmitting to and/or receiving from a UE. NR systems have supported Multi-TRP operation in transparent mode since 3GPP Release 15 (Rel-15). Beginning with 3GPP Rel-16, NR systems have supported Multi-TRP non-coherent joint transmission (NCJT) schemes for physical downlink shared channel (PDSCH). Beginning with 3GPP Rel-18, NR systems have supported Multi-TRP coherent joint transmission (CJT) schemes for PDSCH.

The TRPs involved in a Multi-TRP NCJT scheme may not be perfectly synchronized and/or may not have an ideal backhaul connection. The TRPs involved in a Multi-TRP CJT scheme, in theory, are perfectly synchronized and have an ideal backhaul connection. However, in practice, perfect synchronization between TRPs is hard for a network to maintain. Thus, in reality, there may be timing, frequency, and/or phase offsets between the TRPs involved in a Multi-TRP CJT scheme. These offsets need to be accounted for or a network and UE may lose their ability to maintain Multi-TRP CJT scheme operation.

Described herein are UE reporting enhancements for CJT. The enhancements include channel measurement resource (CMR) configurations for identifying a set of channel state information (CSI) reference signal (CSI-RS) resources. The set of CSI-RS resources may include different subsets of one or more CSI-RS resources for the different TRPs in a set of TRPs identified for a CJT deployment between the set of TRPs and the UE.

Further reporting enhancements pertain to CSI processing unit (CPU) counting; active CSI-RS port counting; and aperiodic CSI processing time determinations.

The UE reporting enhancements described herein are targeted to NR frequency range 1 (FR1), including both frequency division duplex (FDD) and time division duplex (TDD) scenarios, but can be applied to other frequency ranges as well.

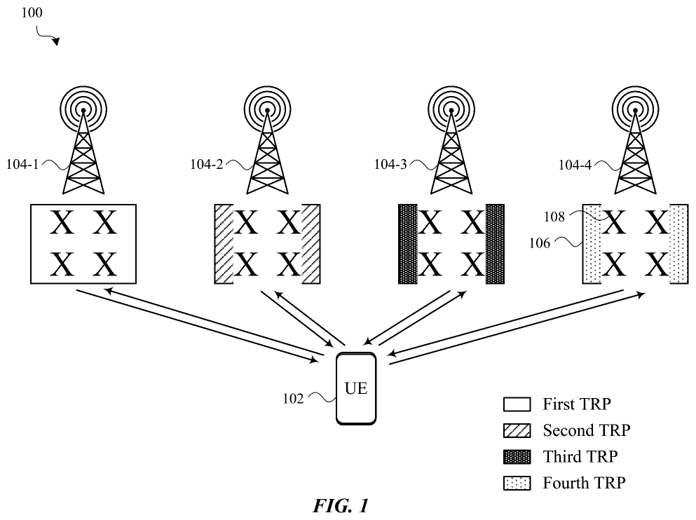

FIG. 1 illustrates a wireless communication system 100 including an example UE 102 and set of TRPs 104-1, 104-2, 104-3, 104-4. The wireless communication system 100 may be configured to implement the methods described herein. In some embodiments, the system 100 may operate in a CJT scheme. To assist a network device (or network) in synchronizing the TRPs 104-1, 104-2, 104-3, 104-4, each TRP 104-1, 104-2, 104-3, 104-4 may transmit one or more CSI-RS resources, and the UE 102 may receive and measure some or all of the CSI-RS resources. The UE may determine time, frequency, and/or phase offsets between the TRPs 104-1, 104-2, 104-3, 104-4, and may transmit a CSI report based on its measurements and determinations to the network (e.g., to one of the TRPs).

Each TRP 104-1, 104-2, 104-3, 104-4 may include a respective antenna panel 106, or more than one antenna panel. Each antenna panel 106 may include a set of antenna elements 108 for transmitting to the UE 102 on a respective transmit (Tx) beam and/or receiving from the UE 102 on a respective receive (Rx) beam. Similarly, the UE 102 may include one or more antenna panels, each including a set of antenna elements, for receiving from the TRPs 104-1, 104-2, 104-3, 104-4 on respective Rx beams and/or transmitting to the TRPs 104-1, 104-2, 104-3, 104-4 on respective Tx beams.

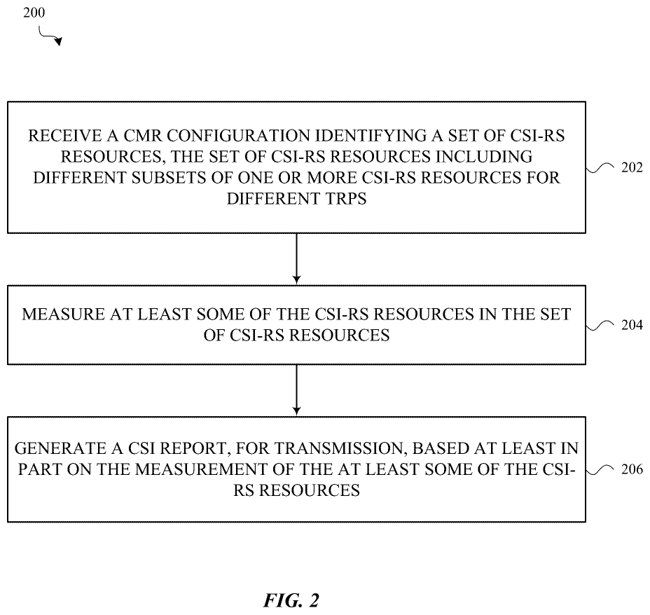

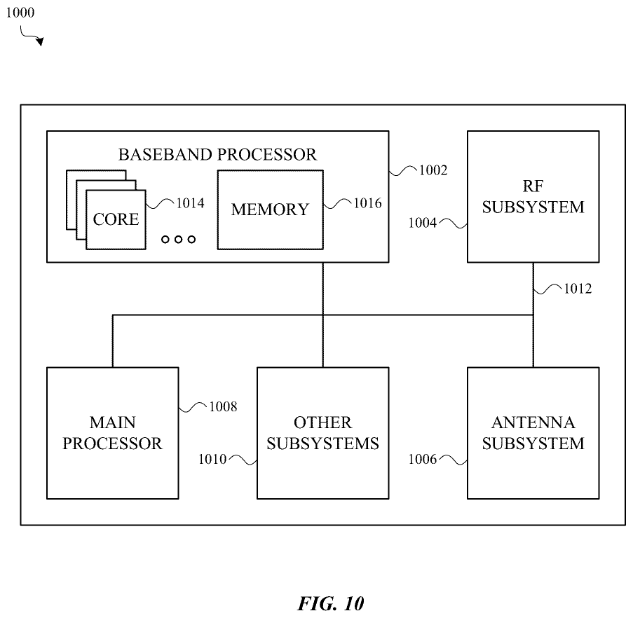

FIG. 2 shows an example method 200 of wireless communication by a UE. In some cases, the UE may be the wireless device or UE 102, 802, 804, 902, or 1000. In some cases, the method 200 may be performed by a baseband processor of the UE, such as the baseband processor described with reference to FIG. 10. As the baseband processor performs the method 200, the baseband processor may cause other components of the UE to perform, or discontinue, various operations. Although the method 200 describes a UE reporting enhancement for coordinated joint transmission (CJT) deployments under non-ideal synchronization and backhaul, the method 200 may alternatively be performed in other contexts.

At 202, the method 200 may include receiving (e.g., from a network device) configuration signaling (e.g., a Radio Resource Control (RRC) message) that indicate(s) a channel measurement resource (CMR) configuration identifying a set of channel state information (CSI) reference signal (CSI-RS) resources. The set of CSI-RS resources may include different subsets of one or more CSI-RS resources for different transmission and reception points (TRPs) in a set of TRPs identified for a CJT deployment. The CJT deployment may be between the set of TRPs and the UE. The set of TRPs may include two or more TRPs and may or may not be limited to a maximum number of TRPs. In some embodiments, the set of TRPs may be limited to X TRPs (e.g., X=4 TRPs).

At 204, the method 200 may include measuring at least some of the CSI-RS resources in the set of CSI-RS resources.

At 206, the method 200 may include generating a CSI report, for transmission (e.g., to a network device), based at least in part on the measurement(s) obtained at 204. In some embodiments, the CSI report may be transmitted on a physical uplink shared channel (PUSCH) or a physical uplink control channel (PUCCH). The CSI report may include, for example, one or more indications of a time offset (or offsets; i.e., time misalignments) and frequency/phase offset (or offsets) between different TRPs in the set of TRPs (e.g., an indication or indications of a first time/frequency/phase offset between a first TRP and a second TRP, an indication or indications of a second time/frequency/phase offset between a second TRP and a third TRP, and so on (i.e., inter-TRP offsets)).

The method 200 may be variously embodied, extended, or adapted, as described in the following paragraphs and elsewhere in this description.

In some embodiments of the method 200, each subset of one or more CSI-RS resources may consist of one CSI-RS resource, which CSI-RS resource may be unique for a particular TRP. For example, the set of CSI-RS resources may include a first CSI-RS resource for a first TRP, a second CSI-RS resource for a second TRP, and so on. In some embodiments of the method 200, each subset of one or more CSI-RS resources may include multiple CSI-RS resources, with each CSI-RS resource being unique for a particular TRP. For example, the set of CSI-RS resources may include a first CSI-RS resource and a second CSI-RS resource for a first TRP, a third CSI-RS resource and a fourth CSI-RS resource for a second TRP, and so on. Each subset of one or more CSI-RS resources may include a same number of CSI-RS resources (and thus, each TRP may be represented by a same number of CSI-RS resources), or different subsets of one or more CSI-RS resources may include different numbers of CSI-RS resources (and thus, different TRPs may be represented by different numbers of CSI-RS resources).

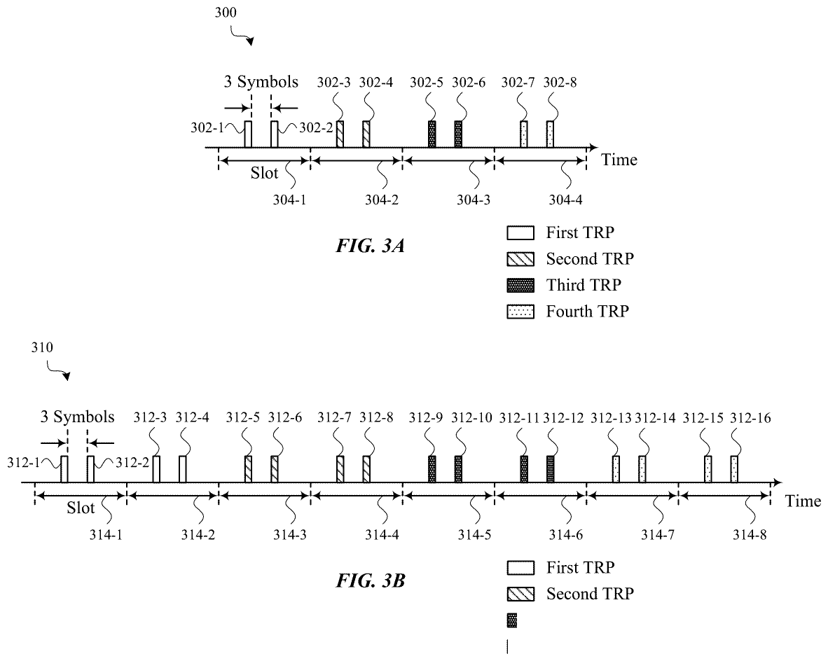

In some embodiments of the method 200, each subset of one or more CSI-RS resources in the different subsets of one or more CSI-RS resources may consist of 2 CSI-RS resources or 4 CSI-RS resources, and thus each TRP may be represented by either 2 CSI-RS resources or 4 CSI-RS resources. In some embodiments, the 2 or 4 CSI-RS resources representing a TRP may follow a tracking reference signal (TRS) pattern. For example, if 2 CSI-RS resources are configured per TRP and follow a TRS pattern, the 2 CSI-RS resources may be transmitted to the UE in a same slot, with 3 symbols separating the 2 CSI-RS resources (see, FIG. 3A). As shown in the timeline 300 of FIG. 3A, 2 CSI-RS resources 302-1, 302-2 are transmitted by a first TRP within a first slot 304-1 and separated by 3 symbols; 2 CSI-RS resources 302-3, 302-4 are transmitted by a second TRP within a second slot 304-2; 2 CSI-RS resources 302-5, 302-6 are transmitted by a third TRP within a third slot 304-3; and 2 CSI-RS resources 302-7, 302-8 are transmitted from a fourth TRP within a fourth slot 304-4. Although the first, second, third, and fourth slots 304-1, 304-2, 304-3, 304-4 do not need to be sequential slots, sequential slots can shorten the duration for CMR transmission and reception.

As another example, if 4 CSI-RS resources are configured per TRP and follow a TRS pattern, the 4 CSI-RS resources may be transmitted to the UE in two consecutive slots, with 3 symbols separating the 2 CSI-RS resources in each slot (see, FIG. 3B). As shown in the timeline 310 of FIG. 3B, 2 CSI-RS resources 312-1, 312-2 are transmitted by a first TRP within a first slot 314-1 and separated by 3 symbols, and 2 more CSI-RS resources 312-3, 312-4 are transmitted by the first TRP within a second slot 314-2 that immediately follows the first slot 314-1; 2 CSI-RS resources 312-5, 312-6 are transmitted by a second TRP within a third slot 314-3, and 2 more CSI-RS resources 312-7, 312-8 are transmitted by the second TRP within a fourth slot 314-4 that immediately follows the third slot 314-3; 2 CSI-RS resources 312-9, 312-10 are transmitted by a third TRP within a fifth slot 314-5, and 2 more CSI-RS resources 312-11, 312-12 are transmitted by the third TRP within a sixth slot 314-6 that immediately follows the fifth slot 314-5; and 2 CSI-RS resources 312-13, 312-14 are transmitted from a fourth TRP within a seventh slot 314-7, and 2 more CSI-RS resources 312-15, 312-16 are transmitted from the fourth TRP within an eighth slot 314-8 that immediately follows the seventh slot 314-7. Although the different pairs of slots 314-1/314-2, 314-3/314-4, 314-5/314-6, 314-7/314-8 do not need to be sequential slots, sequential slots can shorten the duration for CMR transmission and reception.

In each of the embodiments shown in FIGS. 3A and 3B, the number of CSI-RS resources representing each TRP is the same (i.e., the different subsets of one or more CSI-RS resources for the different TRPs each have 2 CSI-RS resources or each have 4 CSI-RS resources). The CSI-RS resources for each TRP are also transmitted in a same number of slots (i.e., the different subsets of one or more CSI-RS resources for the different TRPs are each transmitted in one slot or each transmitted in 2 slots).

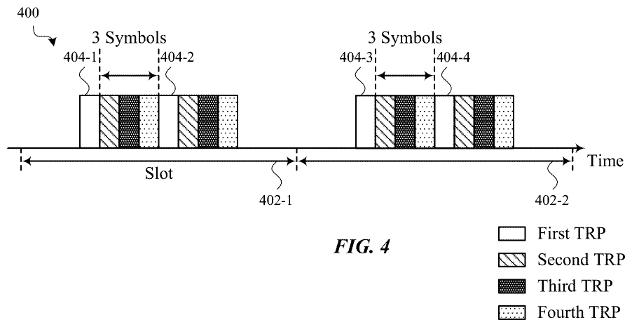

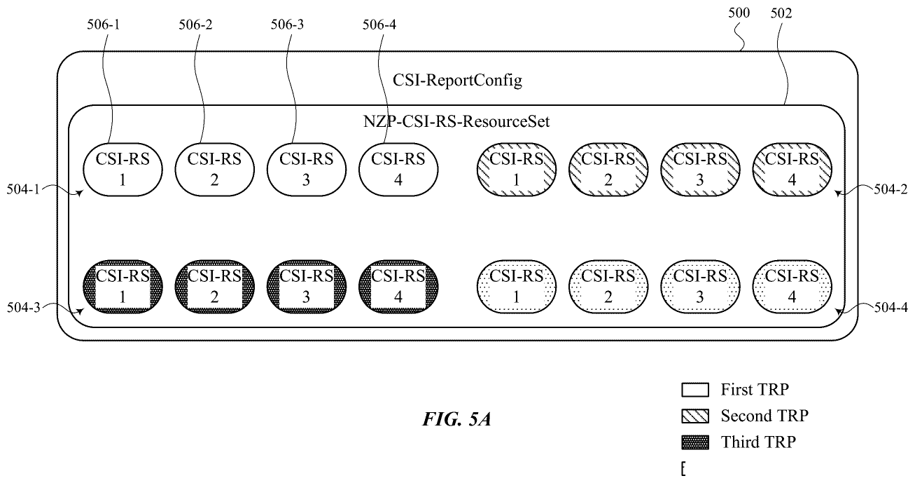

In some embodiments of the method 200, the CMR configuration may schedule the different subsets of one or more CSI-RS resources (for the different TRPs) in different slots, as shown in FIGS. 3A and 3B. In some embodiments of the method 200, the CMR configuration may interleave (or overlap) the different subsets of one or more CSI-RS resources (for the different TRPs) in a same set of one or more slots. For example, FIG. 4 shows a timeline 400 for transmitting 4 CSI-RS resources per TRP, with all of the CSI-RS resources being transmitted in 2 slots 402-1, 402-2. For a particular TRP, 2 CSI-RS resources are transmitted in each slot 402-1, 402-2. For example, for a first TRP, 2 CSI-RS resources 404-1, 404-2 are transmitted in a first slot 402-1 and separated by 3 symbols, and 2 CSI-RS resources 404-3, 404-4 are transmitted in a second slot 402-2 and separated by 3 symbols. CSI-RS resources for other TRPs are interleaved with the CSI-RS resources 404-1, 404-2, 404-3, 404-4 for the first TRP. In some cases, interleaved or overlapping transmissions of CSI-RS resources for different TRPs may be explicitly supported in a standard (e.g., a 3GPP Technical Specification (TS)). In some cases, interleaved or overlapping transmissions of CSI-RS resources may be allowed if signaled to a UE by a network device and/or if a UE indicates to a network that it has a UE capability to support interleaved or overlapping transmissions of CSI-RS resources. The transmission of interleaved or overlapping CSI-RS resources for different TRPs can shorten the duration for CMR transmission and reception. In some embodiments of the method 200, interleaved or overlapping transmissions of one or more CSI-RS resources for different TRPs may not be allowed.

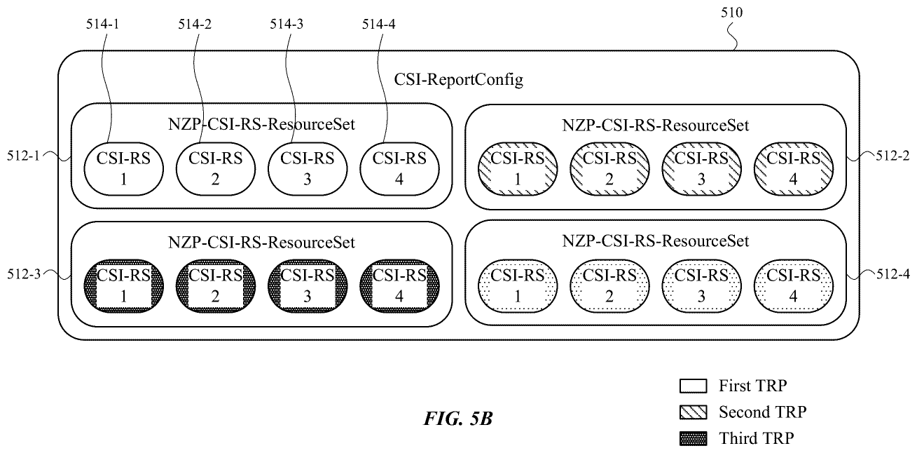

In some embodiments of the method 200, the set of CSI-RS resources may be defined by a single non-zero power (NZP) CSI-RS resource set of the CMR configuration. In these embodiments, different groups of 2 or 4 NZP CSI-RS resources within the single NZP CSI-RS resource set may be used to represent the different subsets of one or more CSI-RS resources for different TRPs. By way of example, FIG. 5A shows a CSI report configuration 500 (e.g., CSI-ReportConfig) including a single NZP CSI-RS resource set 502 (e.g., a NZP-CSI-RS-ResourceSet), with the single NZP CSI-RS resource set 502 including four subsets of CSI-RS resources 504-1, 504-2, 504-3, 504-4, and with each subset of CSI-RS resources 504-1, 504-2, 504-3, 504-4 including 4 CSI-RS resources 506-1, 506-2, 506-3, 506-4 (e.g., 4 NZP-CSI-RS-Resource) labeled CSI-RS 1, CSI-RS 2, CSI-RS 3, and CSI-RS 4, respectively.

In some embodiments of the method 200, each subset of one or more CSI-RS resources in the different subsets of one or more CSI-RS resources may be included in a different NZP CSI-RS resource set of the CMR configuration. By way of example, FIG. 5B shows a CSI report configuration 510 (e.g., CSI-ReprtConfig) including 4 NZP CSI-RS resource sets 512-1, 512-2, 512-3, 512-4 (4 instances of NZP-CSI-RS-ResourceSet). Each NZP CSI-RS resource set 512-1, 512-2, 512-3, 512-4 may include a subset of CSI-RS resources representing a respective TRP (e.g., 4 CSI-RS resources 514-1, 514-2, 514-3, 514-4 (e.g., 4 NZP-CSI-RS-Resource) labeled CSI-RS 1, CSI-RS 2, CSI-RS 3, and CSI-RS 4).

In some embodiments of the method 200, the CSI report may be transmitted, at 206, regardless of what measurements are obtained at 204.

In some embodiments of the method 200, the measurement of the at least some of the CSI-RS resources in the set of CSI-RS resources, at 204, may include measuring at least one CSI-RS resource in each of the subsets of one or more CSI-RS resources. In these embodiments, the CSI report may be generated at 206, for transmission, in response to measuring the at least one CSI-RS resource in each of the subsets of one or more CSI-RS resources. That is, a standard (e.g., a 3GPP TS), or the CMR configuration, may specify that the CSI report is not to be transmitted unless the measurements obtained at 204 include a measurement of at least one CSI-RS resource in each of the subsets of one or more CSI-RS resources (i.e., at least one measurement for each TRP). This may ensure that the CSI report carries useful information pertaining to time/frequency/phase offset(s) between all of the TRPs in the set of TRPs. By way of example, the UE may not be able to measure each received CSI-RS resource because it is operating in a connected mode discontinuous reception (C-DRX) mode and does not monitor each of the slots in which CSI-RS resources are transmitted.

In some embodiments of the method 200, the measurement of the at least some of the CSI-RS resources in the set of CSI-RS resources, at 204, may include measuring at least one CSI-RS resource in each of a predetermined or configured number of the subsets of one or more CSI-RS resources. In these embodiments, the CSI report may be generated at 206, for transmission, in response to measuring the at least one CSI-RS resource in each of the predetermined or configured number of the subsets of one or more CSI-RS resources. That is, a standard (e.g., a 3GPP TS), or the CMR configuration, may specify that the CSI report is not to be transmitted unless the measurements obtained at 204 include a measurement of at least one CSI-RS resource in each of a predetermined or configured number of subsets of one or more CSI-RS resources (i.e., at least one measurement for at least N TRPs of the set of TRPs, where N≤X). This may ensure that the CSI report carries useful information pertaining to at least one TRP in the set of TRPs, or useful information pertaining to time/frequency/phase offset(s) between at least some of the TRPs in the set of TRPs.

For purposes of conditionally generating the CSI report at 206, for transmission, based at least in part on 1) measuring at least one CSI-RS resource in each of the subsets of one or more CSI-RS resources, or 2) measuring at least one CSI-RS resource in each of a predetermined or configured number of the subsets of one or more CSI-RS resources, a standard (e.g., a 3GPP TS), the network, or in some cases the CMR configuration may place a further condition on the “measuring at least one CSI-RS resource in a subset of one or more CSI-RS resources.” The condition may be that a “measurement” is obtained for a subset of one or more CSI-RS resources after the UE receives and measures 2 CSI-RS resources in a slot (i.e., 2 CSI-RS resources associated with one TRP). Alternatively, the condition may be that a “measurement” is obtained for a subset of one or more CSI-RS resources after the UE receives and measures 4 CSI-RS resources across 2 consecutive slots (i.e., 4 CSI-RS resources associated with one TRP).

In some embodiments, the method 200 may include determining a number of CPUs occupied by the UE as a result of the UE measuring at least some of the CSI-RS resources in the set of CSI-RS resources. In these embodiments, the method 200 may include generating and/or transmitting the CSI report, at 206, in accordance with the occupied number of CPUs, or otherwise generating and/or transmitting CSI reports of the UE in accordance with the occupied number of CPUs.

In some embodiments of the method 200, the number of CPUs occupied by the UE as a result of the UE measuring at least some of the CSI-RS resources in the set of CSI-RS resources may be based at least in part on (and in some cases may be equal to) a count of CPUs. The count of CPUs may be equal to a number of TRPs (i.e., N_{TRP}) in the set of TRPs, or to a total number of CSI-RS resources (N_{CSI-RS}) in the set of CSI-RS resources (i.e., the number of CSI-RS resources configured across all of the TRPs in the set of TRPs), or to a fixed number of CPUs defined by a capability of the UE (i.e., a UE capability) or a standard (e.g., a 3GPP TS). In some embodiments, the count of CPUs may be limited by a maximum count of 8.

In some embodiments of the method 200, the number of CPUs (i.e., O_{CPU}) occupied by the UE as a result of the UE measuring at least some of the CSI-RS resources in the set of CSI-RS resources may be based at least in part on a count of CPUs (computed, in some examples, as described above) multiplied by a scaling factor (X). For example, the number of occupied CPUs may be computed as:

$${O}_{CPU} = X \cdot {N}_{TRP}$$

$$or$$

$${O}_{CPU} = X \cdot {N}_{CSI - RS}$$

$$or$$

$${O}_{CPU} = X \cdot N$$

where N is a fixed number and X≥1. In some embodiments, the method 200 may include transmitting the scaling factor (e.g., to a network device) as a UE capability. In some embodiments, the scaling factor may be a pre-defined value (e.g., a value indicated in a standard (e.g., a 3GPP TS)). In some embodiments, O_{CPU} may be limited to a maximum of 8.

In some embodiments of the method 200, the scaling factor (X) may be the same for different counts of CPUs. For example, the scaling factor may be the same for different values of N_{TRP} or N_{CSI-RS}. In some embodiments of the method 200, the scaling factor may depend on the count of CPUs. For example, the scaling factor may differ for different values of N_{TRP} or N_{CSI-RS}.

In some embodiments, the method 200 may include reporting, to a network, the occupied number of CPUs; how CPUs are counted; or the scaling factor used to determine an occupied number of CPUs.

In some embodiments, the method 200 may include determining a number of active CSI-RS resources and/or ports (Y) pertaining to the UE's measurement of at least some of the CSI-RS resources in the set of CSI-RS resources, with Y≥1. By way of example, the number of active CSI-RS resources and/or ports may be equal to a number of TRPs in the set of TRPs; to a total number of CSI-RS resources in the set of CSI-RS resources; or to a fixed number defined by a capability of the UE or a standard (e.g., a 3GPP TS).

In some embodiments, the method 200 may include reporting, to a network, the number of active CSI-RS resources and/or ports.

In some embodiments, the method 200 may include generating the CSI report for transmission in accordance with a CSI priority (i.e., determining whether or not to transmit the CSI report based on its priority). In these embodiments, and by way of example, the CSI priority may be one of: the same as a link adaptation (LA) CSI priority; the same as a beam management CSI priority; less than the LA CSI priority; or higher than the LA CSI priority but lower than the BM CSI priority. A CSI priority that is the same as an LA CSI priority may be used when the CSI parameter reportQuantity does not contain a reference signal received power (RSRP) or signal to interference and noise ratio (SINR). A CSI priority that is the same as a BM CSI priority may be used when the CSI parameter reportQuantity does contain an RSRP or SINR.

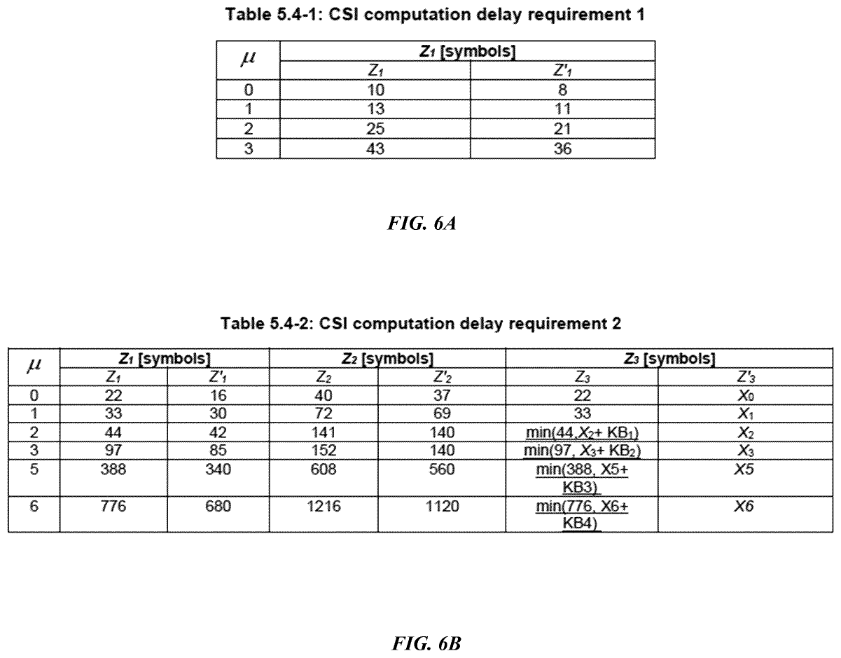

In some embodiments of the method 200, the CSI report may be transmitted on a PUSCH, at 206, in accordance with an aperiodic CSI processing time (i.e., an aperiodic CSI computation delay). For example, the method 200 may include receiving a physical downlink control channel (PDCCH) that includes an aperiodic CSI request, and the CSI report may be transmitted in accordance with a parameter Z indicating a minimum time duration between an end of the PDCCH and a start of the PUSCH, and in accordance with a parameter Z′ indicating a minimum time duration between a last measurement of a CSI-RS resource in the set of CSI-RS resources and the start of the PUSCH. There are already two tables of values defined for the parameters Z and Z′ in 3GPP TS 38.214. Table 5.4-1 of 3GPP TS 38.214, reproduced in FIG. 6A, defines values of Z and Z′ for low latency aperiodic CSI. Table 5.4-2 of 3GPP TS 38.214, reproduced in FIG. 6B, defines values of Z and Z′ for regular latency aperiodic CSI.

In some cases, a standard may indicate that a UE is not expected to support the values of Z and Z′ shown in Table 5.4-1 (see, FIG. 6A) when determining the aperiodic CSI processing time for a CSI report related to a CJT. In some cases, a UE may be allowed to support the values of Z and Z′ shown in Table 5.4-1 when determining the aperiodic CSI processing time for a CSI report related to a CJT, and whether the UE supports the values of Z and Z′ shown in Table 5.4-1 may be reported by means of a UE capability (e.g., a UE capability transmitted by the UE to a network device). In these latter cases, the method 200 may include transmitting a UE capability that indicates whether the UE supports the values of Z and Z′ shown in Table 5.4-1. For example, if the UE supports the values of Z and Z′ shown in Table 5.4-1, the UE may transmit an indication of a UE capability to support Table 5.4-1. Optionally, the method 200 may also include transmitting relaxation symbols (r) for the UE's support of the values of Z and Z′ shown in Table 5.4-1. The r symbols may be reported differently for different sub-carrier spacing (SCS; i.e., u). The r symbols may also be different for Z and for Z′. The r symbols may also be different for different numbers of CSI-RS resources in the set of CSI-RS resources.

In some embodiments of the method 200, the Z₁ values in Table 5.4-2 of 3GPP TS 38.214 may be used as a set of baseline values for the parameters Z and Z′ when determining the aperiodic CSI processing time for a CSI report related to a CJT. When the Z₁ values are used as a set of baseline values, the method 200 may further include transmitting an indication of whether the Z₂ values in Table 5.4-2 are needed. For example, if the UE also needs the Z₂ values, the UE may transmit an indication of a UE capability to support the Z₂ values as a set of non-baseline values for the parameters Z and Z′. In other embodiments, the Z₂ values in Table 5.4-2 may be used as the set of baseline values for the parameters Z and Z′ when determining the aperiodic CSI processing time for a CSI report related to a CJT. When the Z₂ values are used as a set of baseline values, the method 200 may further include transmitting an indication of whether the Z₁ values in Table 5.4-2 are needed. For example, if the UE also needs the Z₁ values, the UE may transmit an indication of a UE capability to support the Z₁ values as a set of non-baseline values for the parameters Z and Z′. Regardless of whether the Z₁ or Z₂ values in Table 5.4-2 are used as a set of baseline values, and regardless of whether the Z₂ or Z₁ are also needed, the method 200 may include transmitting relaxation symbols (r) for the Z₁ and/or Z₂ values shown in Table 5.4-2. The r symbols may be reported differently for different sub-carrier spacing (SCS; i.e., μ). The r symbols may also be different for Z and for Z′. The r symbols may also be different for different numbers of CSI-RS resources in the set of CSI-RS resources.

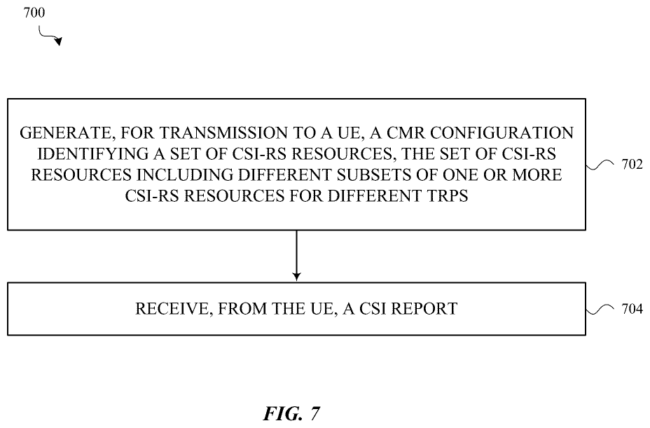

FIG. 7 shows an example method 700 of wireless communication by a network device. In some cases, the network device may be the network device (or TRP) 104-1, 104-2, 104-3, 104-4, 812, 814, or 920. In some cases, the method 700 may be performed by a baseband processor of the network device. As the baseband processor performs the method 700, the baseband processor may cause other components of the network device to perform, or discontinue, various operations. Although the method 700 describes a UE reporting enhancement for CJT deployments under non-ideal synchronization and backhaul, the method 700 may alternatively be performed in other contexts.

At 702, the method 700 may include generating, for transmission to a UE, configuration signaling (e.g., an RRC message) that indicates a CMR configuration identifying a set of CSI-RS resources. The set of CSI-RS resources may include a different subset of one or more CSI-RS resources for different TRPs in a set of TRPs identified for a CJT deployment. The CJT deployment may be between the set of TRPs and the UE. The set of TRPs may include two or more TRPs and may or may not be limited to a maximum number of TRPs. In some embodiments, the set of TRPs may be limited to X TRPs (e.g., X=4 TRPs). In some embodiments, the network device that performs the method 700 may also provide one or more of the TRPs in the set of TRPs.

At 704, the method 700 may optionally include receiving, from the UE, a CSI report. The CSI report may be based at least in part on the UE's measurement of at least some of the CSI-RS resources. In some embodiments, the CSI report may be received on a PUSCH or PUCCH. The CSI report may include, for example, one or more indications of a time offset (or offsets; i.e., time misalignments) and frequency/phase offset (or offsets) between different TRPs in the set of TRPs (e.g., an indication or indications of a first time/frequency/phase offset between a first TRP and a second TRP, an indication or indications of a second time/frequency/phase offset between a second TRP and a third TRP, and so on (i.e., inter-TRP offsets)).

The method 700 may be variously embodied, extended, or adapted, as described in the following paragraphs and elsewhere in this description.

In some embodiments of the method 700, the CSI-RS resources may be defined, configured, grouped, patterned, or scheduled as described, for example, with reference to FIGS. 2-5B.

In some embodiments of the method 700, a standard (e.g., a 3GPP TS) and/or the CMR configuration may configure or place reporting conditions on the CSI report, as described, for example, with reference to FIG. 2.

In some embodiments, the method 700 may include determining a number of CPUs occupied by the UE based on a UE measurement of at least some of the CSI-RS resources in the set of CSI-RS resources. In these embodiments, the method 700 may include at least one of receiving the CSI report, at 704, in accordance with the occupied number of CPUs, or configuring CSI reporting of the UE in accordance with the occupied number of CPUs. Configuring CSI reporting of the UE may include, for example, configuring the CMR configuration transmitted at 702 or configuring a further CMR configuration for the UE.

In some embodiments of the method 700, the number of CPUs occupied by the UE as a result of the UE measuring at least some of the CSI-RS resources in the set of CSI-RS resources may be based at least in part on (and in some cases may be equal to) a count of CPUs. The count of CPUs may be equal to a number of TRPs (i.e., N_{TRP}) in the set of TRPs, or to a total number of CSI-RS resources (N_{CSI-RS}) in the set of CSI-RS resources (i.e., the number of CSI-RS resources configured across all of the TRPs in the set of TRPs), or to a fixed number of CPUs defined by a capability of the UE (i.e., a UE capability) or a standard (e.g., a 3GPP TS). In some embodiments, the count of CPUs may be limited by a maximum count of 8.

In some embodiments of the method 700, the number of CPUs (i.e., O_{CPU}) occupied by the UE as a result of the UE measuring at least some of the CSI-RS resources in the set of CSI-RS resources may be based at least in part on a count of CPUs (computed, in some examples, as described above) multiplied by a scaling factor (X). For example, the number of occupied CPUs may be computed as:

$${O}_{CPU} = X \cdot {N}_{TRP}$$

$$or$$

$${O}_{CPU} = X \cdot {N}_{CSI - RS}$$

$$or$$

$${O}_{CPU} = X \cdot N$$

where N is a fixed number and X≥1. In some embodiments, the method 700 may include receiving the scaling factor from the UE as a UE capability. In some embodiments, the scaling factor may be a pre-defined value (e.g., a value indicated in a standard (e.g., a 3GPP TS)). In some embodiments, O_{CPU} may be limited to a maximum of 8.

In some embodiments of the method 700, the scaling factor (X) may be the same for different counts of CPUs. For example, the scaling factor may be the same for different values of N_{TRP} or N_{CSI-RS}. In some embodiments of the method 700, the scaling factor may depend on the count of CPUs. For example, the scaling factor may differ for different values of N_{TRP} or N_{CSI-RS}.

In some embodiments, the method 700 may include receiving, from the UE, the occupied number of CPUs, how CPUs are counted, or the scaling factor used to determine an occupied number of CPUs.

In some embodiments, the method 700 may include determining a number of active CSI-RS resources and/or ports (Y) pertaining to the UE measuring at least some of the CSI-RS resources in the set of CSI-RS resources, with Y≥1. By way of example, the number of active CSI-RS resources and/or ports may be equal to a number of TRPs in the set of TRPs; to a total number of CSI-RS resources in the set of CSI-RS resources; or to a fixed number defined by a capability of the UE or a standard (e.g., a 3GPP TS).

In some embodiments, the method 700 may include receiving, from the UE, the number of active CSI-RS resources and/or ports.

In some embodiments, the method 700 may include assigning the CSI report a CSI priority; or the CSI report may be received, at 704, in accordance with a pre-defined priority (e.g., a priority defined in a standard, such as a 3GPP TS). In these embodiments, and by way of example, the CSI priority may be one of the same as an LA CSI priority; the same as a BM CSI priority; less than the LA CSI priority; or higher than the LA CSI priority but lower than the BM CSI priority. A CSI priority that is the same as an LA CSI priority may be used when the CSI parameter reportQuantity does not contain an RSRP or SINR. A CSI priority that is the same as a BM CSI priority may be used when the CSI parameter reportQuantity does contain an RSRP or SINR.

In some embodiments, the method 700 may include determining an aperiodic CSI processing time, as described with reference to FIG. 2.

Embodiments contemplated herein include one or more non-transitory computer-readable media storing instructions to cause an electronic device, upon execution of the instructions by one or more processors of the electronic device, to perform one or more elements of the method 200 or 700. In the context of method 200, this non-transitory computer-readable media may be, for example, a memory of a UE (such as a memory 906 of a wireless device 902 that is a UE, as described herein). In the context of method 700, this non-transitory computer-readable media may be, for example, a memory of a network device (such as a memory 924 of a network device 920, as described herein).

Embodiments contemplated herein include an apparatus having logic, modules, or circuitry to perform one or more elements of the method 200 or 700. In the context of method 200, this apparatus may be, for example, an apparatus of a UE (such as a wireless device 902 that is a UE). In the context of method 700, this apparatus may be, for example, an apparatus of a network device (such as a network device 920, as described herein).

Embodiments contemplated herein include an apparatus having one or more processors and one or more computer-readable media, using or storing instructions that, when executed by the one or more processors, cause the one or more processors to perform one or more elements of the method 200 or 700. In the context of method 200, this apparatus may be, for example, an apparatus of a UE (such as a wireless device 902 that is a UE, as described herein). In the context of the method 700, this apparatus may be, for example, an apparatus of a network device (such as a network device 920, as described herein).

Embodiments contemplated herein include a signal as described in or related to one or more elements of the method 200 or 700.

Embodiments contemplated herein include a computer program or computer program product having instructions, wherein execution of the program by a processor causes the processor to carry out one or more elements of the method 200 or 700. In the context of method 200, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 700, the processor may be a processor of a network device (such as a processor(s) 922 of a network device 920, as described herein), and the instructions may be, for example, located in the processor and/or on a memory of the network device (such as a memory 924 of a network device 920, as described herein).

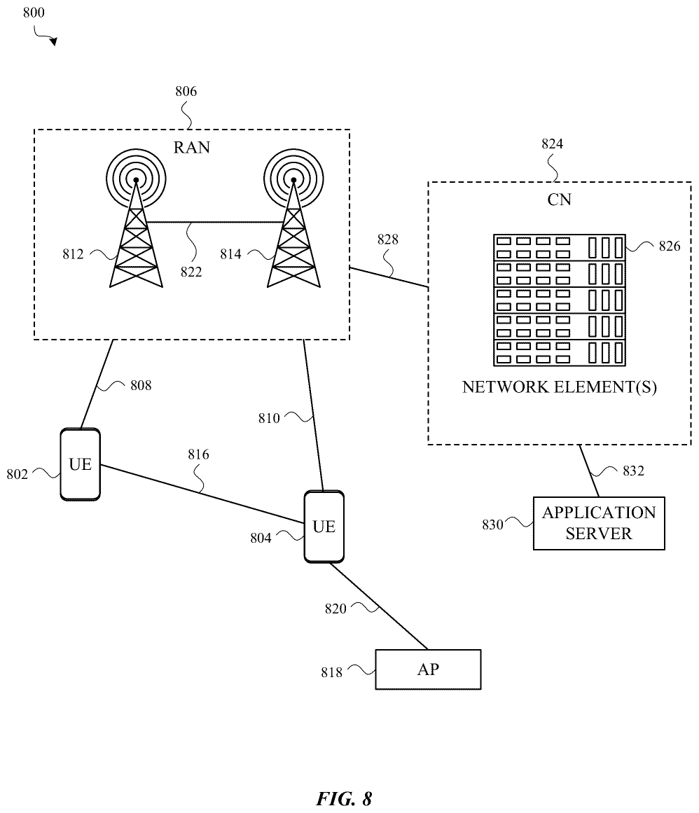

FIG. 8 illustrates an example architecture of a wireless communication system, according to embodiments described herein. The following description is provided for an example wireless communication system 800 that operates in conjunction with the LTE system standard and/or 5G or NR system standard, as provided by 3GPP TSs.

As shown, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks) but may also comprise any mobile or non-mobile computing device configured for wireless communication.

The UE 802 and UE 804 may be configured to communicatively couple with a RAN 806. In some embodiments, the RAN 806 may be an NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more network devices, such as base station 812 and base station 814, that enable the connection 808 and connection 810.

In this example, the connection 808 and connection 810 are air interfaces to enable such communicative coupling and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In some embodiments, the UE 802 and UE 804 can be configured to communicate using orthogonal frequency-division multiplexing (OFDM) communication signals with each other or with the base station 812 and/or the base station 814 over a multicarrier communication channel in accordance with various communication techniques, such as, but not limited to, an orthogonal frequency-division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more network devices of a RAN (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more network devices of a RAN (e.g., two or more gNBs and the like) that connect to the 5GC, between a base station 812 (e.g., a gNB) connecting to the 5GC and an eNB, and/or between two eNBs connecting to the 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In some embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In some embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VOIP sessions, group communication sessions, etc.) for the UE 802 and UE 804 via the CN 824. The application server 830 may communicate with the CN 824 through an IP communications interface 832.

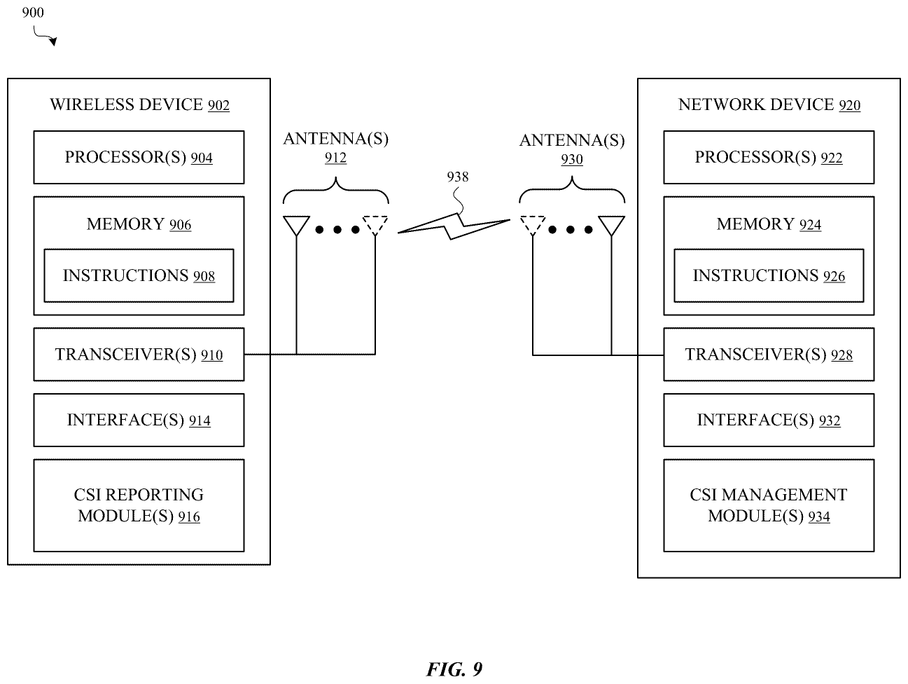

FIG. 9 illustrates an example system 900 for performing signaling 938 between a wireless device 902 and a network device 920, according to embodiments described herein. The system 900 may be a portion of a wireless communication system as herein described. The wireless device 902 may be, for example, a UE of a wireless communication system. The network device 920 may be, for example, a base station (e.g., an eNB or a gNB) or a radio head of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 (also collectively referred to as a transceiver 910) that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, eight, or more; also referred to herein as antenna elements). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In some embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to/from the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include CSI reporting module(s) 916. The CSI reporting module(s) 916 may be implemented via hardware, software, or combinations thereof. For example, the CSI reporting module(s) 916 may be implemented as a processor, circuit, and/or instructions 908 stored in the memory 906 and executed by the processor(s) 904. In some examples, the CSI reporting module(s) 916 may be integrated within the processor(s) 904 and/or the transceiver(s) 910. For example, the CSI reporting module(s) 916 may be implemented by a combination of software components (e.g., executed by a DSP or a general processor) and hardware components (e.g., logic gates and circuitry) within the processor(s) 904 or the transceiver(s) 910.

The CSI reporting module(s) 916 may be used for various aspects of the present disclosure, for example, aspects of FIGS. 1-7, from a wireless device or UE perspective. The CSI reporting module(s) 916 may be used to, for example, receive an indication of a CMR configuration for CSI reporting, measure one or more CSI-RS resources associated with the CMR configuration, and transmit a CSI report for a CJT to a network (e.g., to the network device 920).

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 (also collectively referred to as a transceiver 928) that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more; also referred to herein as antenna elements). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 of a RAN (e.g., a base station, a radio head, etc.) may include interface(s) 932 made up of transmitters, receivers, and other circuitry (e.g., other than the transceiver(s) 928/antenna(s) 930 already described) that enables the network device 920 to communicate with other equipment in a network, and/or that enables the network device 920 to communicate with external networks, computers, databases, and the like for purposes of operations, administration, and maintenance of the network device 920 or other equipment operably connected thereto.

The network device 920 may include one or more CSI management module(s) 934. The CSI management module(s) 934 may be implemented via hardware, software, or combinations thereof. For example, the CSI management module(s) 934 may be implemented as a processor, circuit, and/or instructions 926 stored in the memory 924 and executed by the processor(s) 922. In some examples, the CSI management module(s) 934 may be integrated within the processor(s) 922 and/or the transceiver(s) 928. For example, the CSI management module(s) 934 may be implemented by a combination of software components (e.g., executed by a DSP or a general processor) and hardware components (e.g., logic gates and circuitry) within the processor(s) 922 or the transceiver(s) 928.

The CSI management module(s) 934 may be used for various aspects of the present disclosure, for example, aspects of FIGS. 1-7, from a network device perspective. The CSI management module(s) 934 may be used to, for example, configure a number of CSI-RS resources for use by a wireless device (e.g., the wireless device 902 and/or other wireless devices) to measure and report CSI for a CJT.

FIG. 10 illustrates example components of a UE 1000. By way of example, the UE may be a mobile phone (e.g., a smartphone), a computer (e.g., a laptop or tablet computer), a wearable device (e.g., an electronic watch, fitness device, or head-mounted device), or an IoT device.

The example components of the UE 1000 include a baseband processor 1002, a radio frequency (RF) subsystem 1004, an antenna subsystem 1006, a main processor 1008, and various other subsystems 1010. Some or all of the components may communicate with some or all of the other components via one or more communication buses 1012. In some cases, a communication bus 1012 may provide dedicated communication between two components. In some cases, a communication bus 1012 may be shared by more than two components (e.g., as a multiple purpose communication bus).

The baseband processor 1002 may take various forms, and in some embodiments may include one or more processor cores 1014 and one or more memories (i.e., memory 1016). The memory 1016 may be coupled with the processor core(s) and store instructions that, when executed by the processor core(s), cause the baseband processor 1002 to perform the operations of the method 200 and/or other operations. Execution of the instructions may cause the baseband processor 1002 to transmit or receive control signaling, configuration signaling, information, data, reference signals, and so on. The execution of some instructions may cause the baseband processor 1002 to configure the antenna subsystem 1006 or RF subsystem 1004; to receive control signaling, configuration signaling, information, data, or reference signals over the air, via the antenna subsystem 1006 and the RF subsystem 1004; or to transmit control signaling, configuration signaling, information, data, or reference signals over the air, via the RF subsystem 1004 and the antenna subsystem 1006. The baseband processor 1002 may be provided by a single integrated circuit (IC) or include components distributed among two or more ICs.

The RF subsystem 1004 (or analog front-end (AFE)) may include, for example, one or more analog-to-digital converters (ADCs), digital-to-analog converters (DACs), amplifiers, filters, and so on forming one or more transmitters, receivers, or transceivers. In some embodiments, the RF subsystem 1004 may provide activation, deactivation, or switching of transmit and receive paths, which transmit and receive paths may terminate or begin with antennas of the antenna subsystem 1006. In some embodiments, the RF subsystem 1004 may support multiple simultaneous transmit and receive paths for one or more MIMO configurations. In addition to analog processing functions, the RF subsystem 1004 (or the baseband processor 1002, or a separate subsystem) may perform digital processing functions (e.g., digital processing of signals, information, or data to be transmitted or received).

The antenna subsystem 1006 may include one or more antenna panels, with each antenna panel including one or more antenna elements. The antenna elements of one or more antenna panels may be deployed or operated by the baseband processor 1002 and/or the RF subsystem 1004 in accordance with 3GPP protocols, to form one or more transmit (Tx) beams or receive (Rx) beams for over-the-air transmissions and receptions of control signaling, configuration signaling, information, data, and reference signals, and in some cases may be used to perform a Tx beam sweep or a Rx beam sweep. In some embodiments, the antenna subsystem 1006 may include antennas configured for use in accordance with Wi-Fi®, Bluetooth®, Global Positioning System (GPS) and/or other types of communication protocols.

The main processor 1008 may perform the mission functions of the UE 1000. In some embodiments, the main processor 1008 may manage the receipt of user input, obtain sensor readings, operate a display, trigger haptic feedback, manage the reception or storage of data, enable or disable the baseband processor 1002 or other components of the UE 1000, and/or perform other operations. The main processor 1008 may be provided by a single IC or include components distributed among two or more ICs.

The other subsystems 1010 may include, for example, one or more of a power subsystem, an input/output (I/O) subsystem, a display subsystem, a sensor subsystem, a haptic subsystem, and so on.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A baseband processor, comprising:
at least one processor core; and
memory coupled with the at least one processor core, the memory storing instructions that, when executed by the at least one processor core, cause the baseband processor to at least,
receive configuration signaling that indicates a channel measurement resource (CMR) configuration identifying a set of channel state information (CSI) reference signal (CSI-RS) resources, the set of CSI-RS resources including different subsets of one or more CSI-RS resources for different transmission and reception points (TRPs) in a set of TRPs identified for a coordinated joint transmission (CJT) between the set of TRPs and a user equipment (UE);
measure at least some of the CSI-RS resources in the set of CSI-RS resources; and
generate a CSI report, for transmission, based at least in part on the measurement of the at least some of the CSI-RS resources.

2. The baseband processor of claim 1, wherein each subset of one or more CSI-RS resources in the different subsets of one or more CSI-RS resources consists of two CSI-RS resources or four CSI-RS resources following a tracking reference signal (TRS) pattern.

3. The baseband processor of claim 2, wherein each subset of one or more CSI-RS resources in the different subsets of one or more CSI-RS resources includes a same number of CSI-RS resources.

4. The baseband processor of claim 1, wherein the set of CSI-RS resources is defined by a single non-zero power (NZP) CSI-RS resource set of the CMR configuration.

5. The baseband processor of claim 1, wherein each subset of one or more CSI-RS resources in the different subsets of one or more CSI-RS resources is included in a different non-zero power (NZP) CSI-RS resource set of the CMR configuration.

6. The baseband processor of claim 1, wherein the CMR configuration interleaves the different subsets of one or more CSI-RS resources in a same set of one or more slots.

7. The baseband processor of claim 1, wherein the CMR configuration schedules the different subsets of one or more CSI-RS resources in different slots.

8. The baseband processor of claim 1, wherein measuring the at least some of the CSI-RS resources in the set of CSI-RS resources comprises:
measuring at least one CSI-RS resource in each of the subsets of one or more CSI-RS resources; and
generating the CSI report, for transmission, in response to measuring the at least one CSI-RS resource in each of the subsets of one or more CSI-RS resources.

9. The baseband processor of claim 1, wherein measuring the at least some of the CSI-RS resources in the set of CSI-RS resources comprises:
measuring at least one CSI-RS resource in each of a predetermined or configured number of the subsets of one or more CSI-RS resources; and
generating the CSI report, for transmission, in response to measuring the at least one CSI-RS resource in each of the predetermined or configured number of the subsets of one or more CSI-RS resources.

10. The baseband processor of claim 1, wherein:
the CSI report is generated, for transmission, in accordance with a CSI priority; and
the CSI priority is one of,
a link adaptation (LA) CSI priority;
a beam management (BM) CSI priority;
less than the LA CSI priority; or
higher than the LA CSI priority but lower than the BM CSI priority.

11. A method of wireless communication by a network device, comprising:
generating, for transmission to a user equipment (UE), configuration signaling that indicates a channel measurement resource (CMR) configuration identifying a set of channel state information (CSI) reference signal (CSI-RS) resources, the set of CSI-RS resources including different subsets of one or more CSI-RS resources for different transmission and reception points (TRPs) in a set of TRPs identified for a coordinated joint transmission (CJT) between the set of TRPs and the UE;
determining a number of CSI processing units (CPUs) occupied by the UE based on a UE measurement of at least some of the CSI-RS resources in the set of CSI-RS resources; and
at least one of receiving, from the UE, a CSI report in accordance with the occupied number of CPUs, or configuring CSI reporting of the UE in accordance with the occupied number of CPUs.

12. The method of claim 11, wherein the number of CPUs occupied by the UE is based at least in part on:
a count of CPUs equal to,
a number of TRPs in the set of TRPs; or
a total number of CSI-RS resources in the set of CSI-RS resources; or
a fixed number of CPUs defined by a capability of the UE or a standard.

13. The method of claim 12, wherein the determining is based at least in part on the count of CPUs multiplied by a scaling factor.

14. The method of claim 13, wherein:
the method comprises receiving the scaling factor from the UE as a UE capability; or
the scaling factor is a pre-defined value.

15. The method of claim 13, wherein:
the scaling factor is the same for different counts of CPUs; or
the scaling factor depends on the count of CPUs.

16. The method of claim 12, wherein a maximum count of the count of CPUs is eight.

17. The method of claim 11, further comprising:
determining a number of active CSI-RS resources or ports pertaining to the UE measuring at least some of the CSI-RS resources in the set of CSI-RS resources, the number of active CSI-RS resources or ports equal to,
a number of TRPs in the set of TRPs;
a total number of CSI-RS resources in the set of CSI-RS resources; or
a fixed number defined by a capability of the UE or a standard.

18. A method of wireless communication by a user equipment (UE), comprising:
receiving configuration signaling that indicates a channel measurement resource (CMR) configuration identifying a set of channel state information (CSI) reference signal (CSI-RS) resources, the set of CSI-RS resources including different subsets of one or more CSI-RS resources for different transmission and reception points (TRPs) in a set of TRPs identified for a coordinated joint transmission (CJT) between the set of TRPs and the UE;
receiving a physical downlink control channel (PDCCH) that includes an aperiodic CSI request;
measuring, in response to the aperiodic CSI request, at least some of the CSI-RS resources in the set of CSI-RS resources; and
generating a CSI report, for transmission, based at least in part on the measurement of the at least some of the CSI-RS resources, the CSI report transmitted on a physical uplink shared channel (PUSCH) in accordance with a parameter Z indicating a minimum time duration between an end of the PDCCH and a start of the PUSCH, and in accordance with a parameter Z′ indicating a minimum time duration between a last measurement of a CSI-RS resource in the set of CSI-RS resources and the start of the PUSCH.

19. The method of claim 18, wherein a set of baseline values for the parameters Z and Z′ are taken from or based on:
Z₁ values in Table 5.4-2 of 3GPP TS 38.214; or
Z₂ values in Table 5.4-2 of 3GPP TS 38.214.

20. The method of claim 18, further comprising:
transmitting at least one of:
a first indication of a first UE capability to support Table 5.4-1 of 3GPP TS 38.214; or
a second indication of a second UE capability to support a set of non-baseline values for the parameters Z and Z′, the set of non-baseline values for the parameters Z and Z′ taken from or based on Table 5.4-2 of 3GPP TS 38.214.
